(19) United States
(12) Patent Application Publication
(10) Pub. No.: US 2021/0004146 A1
(43) Pub. Date: Jan. 7, 2021

(54) VIRTUAL DIAL CONTROL

(71) Applicant: Microsoft Technology Licensing, LLC, Redmond, WA (US)

(72) Inventors: Addison Kenan LINVILLE, Kenmore, WA (US); Dong Yoon PARK, Woodinville, WA (US)

(73) Assignee: Microsoft Technology Licensing, LLC, Redmond, WA (US)

(21) Appl. No.: 16/458,372

(22) Filed: Jul. 1, 2019

(51) Int. Cl. G06F 3/0484; G06F 3/01; G06T 19/00; G02B 27/01

(52) U.S. Cl. CPC G06F 3/04847; G06F 3/011; G02B 27/0172; G06T 19/006; G06F 3/017

(57) ABSTRACT

A method for an augmented reality device includes displaying a virtual dial control having a virtual three-dimensional position in a virtual coordinate system. A first real-world three-dimensional position of a human hand is detected and translated into a first effective virtual position relative to the virtual coordinate system. A dial-rotation-initiating gesture is detected from the human hand at the first effective virtual position. A movement of the human hand is tracked from the first real-world three-dimensional position to a second real-world three-dimensional position corresponding to a second effective virtual position. A dial-rotation-terminating gesture is detected from the hand at the second effective virtual position.

### BACKGROUND

Augmented/virtual reality computing devices can be used to provide augmented reality (AR) experiences and/or virtual reality (VR) experiences by presenting virtual imagery to a user. Such devices are frequently implemented as head-mounted display devices (HMDs). Virtual imagery can take the form of one or more virtual shapes, objects, or other visual phenomena that are presented such that they appear as though they are present in the augmented/virtual world.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method for an augmented reality device includes displaying a virtual dial control having a virtual three-dimensional position in a virtual coordinate system. A first real-world three-dimensional position of a human hand is detected and translated into a first effective virtual position relative to the virtual coordinate system. A dial-rotation-initiating gesture is detected from the human hand at the first effective virtual position. A movement of the human hand is tracked from the first real-world three-dimensional position to a second real-world three-dimensional position corresponding to a second effective virtual position. A dial-rotation-terminating gesture is detected from the hand at the second effective virtual position.

### BRIEF DESCRIPTION OF THE DRAWINGS

FIG. 1 schematically illustrates presentation of a virtual dial control.

FIG. 2 illustrates an example method for an augmented reality device.

FIGS. 3A-3D schematically illustrate manipulation of a virtual dial control.

FIGS. 4A and 4B schematically illustrate manipulation of a virtual dial control.

FIGS. 5A and 5B schematically illustrate use of a virtual dial control to adjust a visual property of a virtual object.

FIG. 6 schematically shows an example computing system.

### DETAILED DESCRIPTION

As indicated above, augmented/virtual reality devices may be used to display a wide variety of virtual images. In the case of augmented reality, such virtual images may be presented so that they appear, from the perspective of a user, to be physically present in the user's local environment. In the case of virtual reality, such virtual images may be presented so that they appear, from the perspective of the user, to be present in a completely virtual world.

To avoid repetition, the term “augmented reality device” is used herein to refer to any collection of computer hardware usable to present virtual images to a user eye, whether for augmented/mixed reality applications or virtual reality applications. In some cases, this may be done using a near-eye display, which may be included as part of a head-mounted display device (HMD). The near-eye display may be transparent, partially transparent, or fully opaque. However, near-eye displays are one non-limiting example of a suitable display technology, and any suitable display having any suitable form factor may be used. As another example, a smart phone display may be used. Furthermore, virtual images may be visible alongside real-world imagery, for instance through a transparent display or superimposed over a live camera feed, or virtual images may fully replace a surrounding real-world environment, resulting in a fully virtual experience. For purposes of this disclosure, the term “augmented reality” should be interpreted to include virtual reality.

In some examples, virtual images presented by an augmented reality device may take the form of various controls or user interface elements usable to control the augmented reality device. Specifically, the present disclosure is directed to techniques for presenting and manipulating a virtual dial control. In some cases, rotation of the virtual dial control may result in adjustment of an adjustable parameter associated with the augmented reality device or other device/system—as examples, the virtual dial control may be used to adjust a system volume or display brightness, change a visual property of a virtual object (e.g., position, orientation, size, color), or alter any number of other parameters associated with the augmented reality device or other device/system.

The present disclosure describes virtual dial controls presented as part of an augmented reality experience. However, it will be understood that a virtual dial control as described herein may be presented as part of any suitable software application or computing experience, including those that do not include augmented or virtual reality, Regardless of the context in which the virtual dial control is provided, the virtual dial control may nonetheless be usable to adjust any suitable parameters or provide any suitable function with respect to a computing device that provides the virtual dial control, and/or other systems or devices.

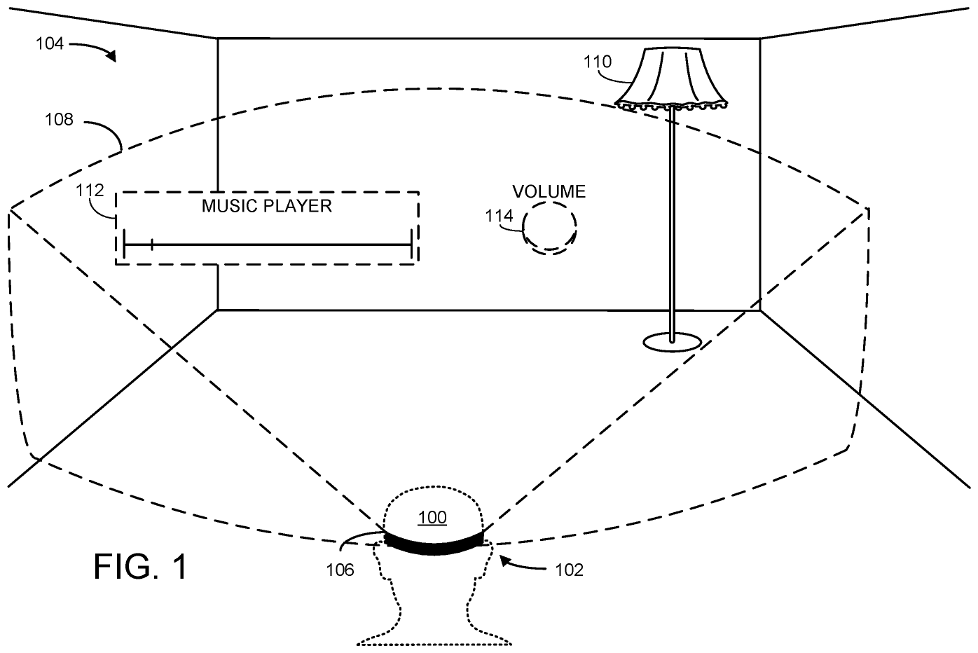

FIG. 1 schematically shows a user 100 using an augmented reality device 102 in a real-world environment 104. In this example, the augmented reality device is an HMD including a near-eye display 106. Via near-eye display 106, user 100 has a field-of-view 108 in which virtual imagery presented by the augmented reality device is visible to the user.

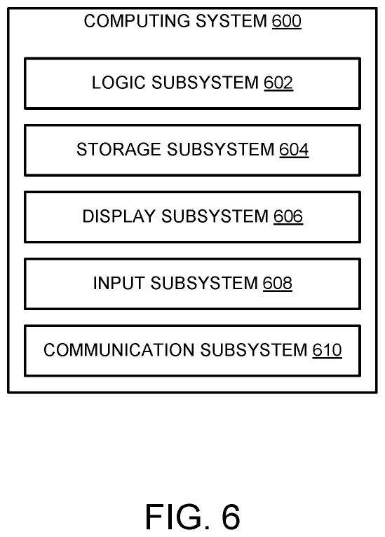

Though the term “augmented reality device” is generally used herein to describe an HMD including one or more near-eye displays, devices having other form factors may instead be used to view and manipulate virtual imagery. For example, virtual imagery may be presented and manipulated via a smartphone or tablet computer facilitating an augmented reality experience. Augmented reality device 102 may in some cases be implemented as computing system 600 described below with respect to FIG. 6.

From the illustrated vantage point, user 100 can see a real-world object 110 (i.e., a lamp) as well as various virtual images generated and displayed by the augmented reality device. Specifically, augmented reality device 102 is displaying an interface 112 for a music player application currently playing audio. Augmented reality device 102 is also displaying a virtual dial control 114. As discussed above, rotation of a virtual dial control may in some cases cause adjustment of an adjustable parameter associated with the augmented reality device, or another device/system. In this case, rotation of virtual dial control 114 adjusts the volume with which the augmented reality device outputs audio from music player application. In FIG. 1, virtual images 112 and 114 are shown in dashed lines to indicate that, while they are visible to the user, they do not physically exist in the real-world environment.

It will be understood that the virtual images depicted in FIG. 1 are non-limiting examples. As discussed above, an augmented reality device may generate and display a wide variety of suitable virtual images, which may be integrated with, superimposed over, or fully replace a surrounding real-world environment. Furthermore, while in FIG. 1 the virtual dial control adjusts an audio volume of the augmented reality device, this is also a nonlimiting example. In general, a virtual dial control may be configured to adjust any number of different suitable adjustable parameters associated with an augmented reality device or any other device/system (e.g., a house thermostat, a house light switch, or a vehicle's cruise control).

A virtual dial control may be implemented through any suitable software application or combination of software applications. For instance, a virtual dial control may be a system-level interface element built-in to an operating system of the augmented reality device. Alternatively, the virtual dial control may be a component of an installable software application, which may be pre-installed on the augmented reality device prior to purchase, or installable by a user after purchase. In any case, the virtual dial control may be usable to control any number of system-level or application-level software functions of the augmented reality device, or another device/system. In implementations where the virtual dial control is used to control an adjustable parameter of an external device, the augmented reality device may communicate changes to the virtual dial via an application programming interface (API) or other suitable mechanism.

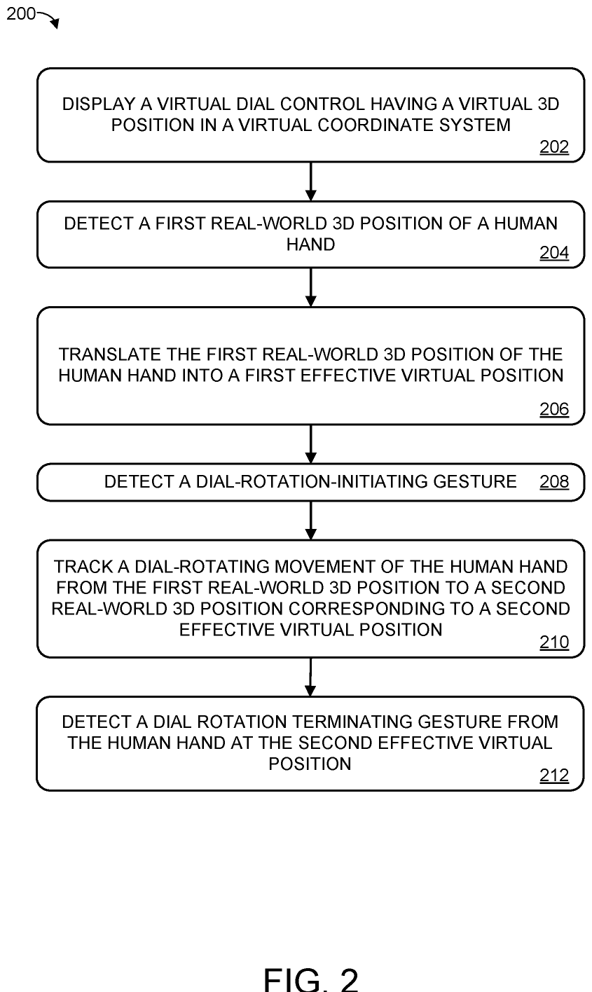

FIG. 2 illustrates an example method 200 for an augmented reality device by which a virtual dial control may be displayed and manipulated. Method 200 may be implemented on any suitable combination of computer hardware having any suitable specifications and form factor. In one example, method 200 may be implemented on computing system 600 described below with respect to FIG. 6.

At 202, method 200 includes displaying a virtual dial control having a virtual three-dimensional position in a virtual coordinate system. This is illustrated in FIG. 1, in which virtual dial control 114 is presented such that it appears to occupy a three-dimensional position within real-world environment 104. Notably, the virtual dial control may have any suitable size, shape, orientation, and general visual appearance. The virtual coordinate system of the virtual dial control may be used to interpret inputs provided to the virtual dial control, and will be discussed in more detail below.

In FIG. 1, virtual dial control 114 is depicted as being cylindrical in shape with a generally vertical orientation, such that the axis of rotation is extending into the page. In other examples, however, a virtual dial control may have other suitable shapes, including non-circular or non-cylindrical shapes. Furthermore, the virtual dial control may have any suitable orientation, including vertical orientations, horizontal orientations (i.e., such that the axis of rotation extends up/down), or slanted orientations.

The virtual dial control may in some cases be “world-locked,” in that the virtual dial control is presented such that it appears to maintain a fixed position even as the augmented reality device is moved around the environment. In some cases, the virtual dial control may maintain a fixed position relative to a real or virtual object, such as a wall, table, user interface element, etc., such that the virtual dial control appears as if it is “affixed” to the real or virtual object. In some cases, the virtual dial control may be “body-locked,” in that it is presented in such a way that it maintains a fixed relationship with respect to the augmented reality device. For instance, in FIG. 1, user 100 may desire that virtual dial control follow their movements around real-world environment 104, such that the user can adjust the volume regardless of their current position within the environment.

In some cases, the virtual dial control need not be persistently visible. For instance, the virtual dial control may be selectively hidden and only revealed when needed—for instance, via a suitable toggle, vocal command, gesture command, etc. In one approach, the virtual dial control may be hidden by default and only displayed when the user interacts with something that the virtual dial control can affect. In the example of FIG. 1, virtual dial control 114 may be selectively displayed while user 100 interacts with interface element 112 corresponding to the music player application and hidden at other times. In other cases, however, the virtual dial control may be displayed persistently.

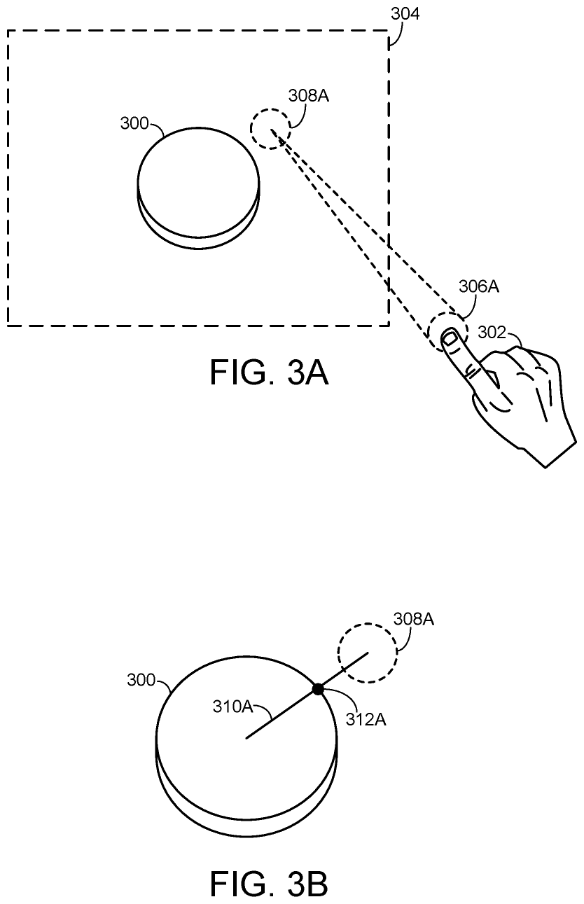

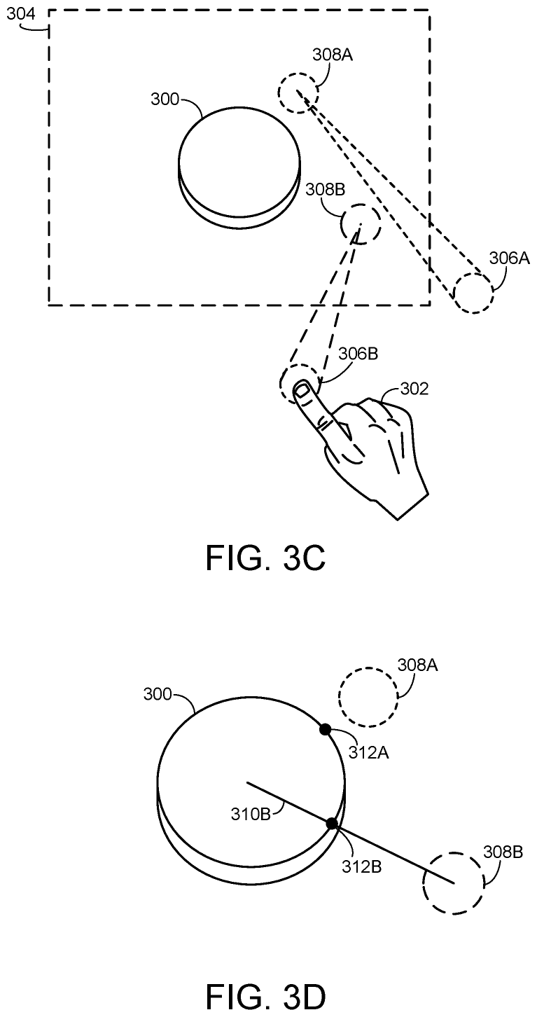

Returning briefly to FIG. 2, at 204, method 200 includes detecting a first real-world three-dimensional (3D) position of a human hand. This is illustrated with respect to FIG. 3A, which shows another example virtual dial control 300 displayed by an augmented reality device. FIG. 3A also depicts a human hand 302, located at a first real-world 3D position with respect to a surrounding real-world environment (e.g., environment 104).

The augmented reality device may be configured to detect the real-world 3D position of the human hand in any suitable way. For instance, the augmented reality device may be communicatively coupled with one or more suitable cameras. Based on images captured by the one or more cameras, the augmented reality device may detect the human hand and resolve it to a particular real-world 3D position. Such cameras may include visible light cameras, infrared cameras, depth cameras, etc. Furthermore, such cameras may be components of the augmented reality device (e.g., on-board cameras), and/or such cameras may be physically separate from the augmented reality device (e.g., distributed throughout a surrounding environment). Human hand detection and tracking may utilize image recognition, including but not limited to artificial neural networks previously trained to recognize a hand in an image captured by a camera. For example, the human hand may be detected by a hand-detecting machine that optionally utilizes a previously trained machine learning classifier to detect hands in images, as will be described in more detail below with respect to FIG. 6.

Additionally, or alternatively, the position of the human hand may be detected in other suitable ways. For instance, the user may hold or wear one or more markers or devices on their hand, which may be visually detected by one or more cameras, and/or resolved to a particular real-world 3D position based on signals emitted by the markers or devices. Furthermore, in some examples, detection and localization of the human hand may be performed by a separate device from the augmented reality device. In other words, the augmented reality device may receive an indication of the current position of the human hand from a different computing device configured to track the real-world 3D position of the human hand in any suitable way.

In any case, regardless of how the real-world 3D position of the human hand is tracked, the position may be expressed relative to any suitable coordinate system and updated with any suitable frequency. As examples, the real-world 3D position of the human hand may be expressed relative to a “world-locked” coordinate system that uses the real-world environment as a frame of reference, a “body-locked” coordinate system that uses a current position of the augmented reality device as a frame of reference, or another suitable coordinate system.

Returning briefly to FIG. 2, at 206, method 200 includes translating the first real-world three-dimensional position of the human hand into a first effective virtual position of the human hand relative to the virtual coordinate system. The specific details associated with “translating” the real-world 3D position of the human hand into the first effective virtual position may vary from implementation to implementation. In some cases, translating the real-world 3D position may involve mapping a particular 3D coordinate (e.g., X, Y, Z) in a real-world coordinate system to a corresponding coordinate (e.g., X*, Y*, Z*) in the virtual coordinate system. Thus, as the human hand moves through a range of 3D coordinates relative to the real-world coordinate system, the effective virtual position of the human hand may move through a corresponding range of coordinates in the virtual coordinate system.

Notably, however, this need not be a 1:1 translation. For example, a 0.5 m vertical change in the real-world position of the hand may be translated into a 0.5 m vertical change in the effective virtual position of the hand. However, in other implementations, the 0.5 m change in the real-world position may be scaled during translation, such that the resulting change in the effective virtual position is more or less than 0.5 m. The amount of scaling, if any, applied during translation may in some cases be different for different directions/axes.

Furthermore, a given real-world movement of the hand may result in a variable change in the effective virtual position depending on various other factors—e.g., a speed of the movement, a proximity of the hand to the dial, or other factors. For instance, the augmented reality device may apply one or more biasing factors during translation, such that the effective virtual position of the hand has a tendency to stay closer to the position of the virtual dial, regardless of movements of the actual hand through the real world.

In some cases, translation may involve projecting the 3D real-world position of the human hand onto a virtual 2D plane. This is also illustrated with respect to FIG. 3A. In this example, the virtual dial control lies on a virtual plane 304 orthogonal to the axis of rotation of the virtual dial control. Positions on this virtual plane may be expressed relative to a virtual coordinate system of the virtual dial control—e.g., expressed as two-dimensional (2D) coordinates relative to a center of the virtual dial control (or another suitable origin). Thus, changes in the real-world position of the hand relative to the X and/or Y axes will be translated into corresponding changes in the effective virtual position of the hand along the virtual plane.

In some cases, during translation of the real-world 3D position, a separation between the real-world 3D position of the human hand and the virtual dial control a long a third dimension (e.g., the Z axis) may be disregarded. In other words, movements of the human hand toward/away from the virtual plane may or may not affect the effective virtual position of the hand on the virtual plane.

In FIG. 3A, the current real-world 3D position of the human hand is expressed as a dashed circle 306A. This is translated into an effective virtual position of the human hand relative to the virtual dial control, which in this case lies on a virtual plane and is shown as a different dashed circle 308A. In this example, the real-world 3D position of the human hand corresponds to an outstretched finger of the human hand, which is being used to interact with the virtual dial control. In other examples, however, other specific portions of the human hand, or the entire human hand itself (e.g., a geometric center of the hand), may be used as the basis for identifying the effective virtual position of the hand.

In some cases, while the human hand is at the first real-world 3D position (e.g., given by dashed circle 306A), the augmented reality device may display a virtual representation of the human hand at the first effective virtual position relative to the virtual coordinate system. In the example of FIG. 3A, a dashed circle is shown that represents the first effective virtual position. However, this is a non-limiting example. In general, the virtual representation may have any shape, size, and general appearance. As examples, the virtual representation may have a similar appearance to all or part of the human hand, take the form of a generic cursor or icon (e.g., a circle, a pointer), or have another suitable appearance. Alternatively, the augmented reality device need not display any representation of the human hand at the effective virtual position. This may be the case, for example, in augmented/mixed reality settings in which the real-world human hand remains visible during rotation of the virtual dial. However, it will be understood that a representation of the hand may optionally still be displayed at the effective virtual position even in augmented/mixed reality settings.

Returning briefly to FIG. 2, at 208, method 200 includes detecting a dial-rotation-initiating gesture from the human hand. The dial-rotation-initiating gesture may take any suitable form. In one example, the dial-rotation-initiating gesture may be a pinch gesture, characterized by convergence of the thumb and index finger (or another finger). However, other suitable dial-rotation-initiating gestures or commands may be used. As additional examples, a dial-rotation-initiating gesture may be performed when a user points at or near the virtual dial control with one or more fingers, hovers all or part of their hand in front or adjacent to the virtual dial control for over a threshold length of time, performs a grasping or twisting gesture, etc.

The dial-rotation-initiating gesture may be detected in any suitable way. For example, the gesture may be detected by a gesture-detecting machine that optionally utilizes a previously trained machine learning classifier to detect one or more specific gestures, including dial-rotation-initiating gestures. This will be described in more detail below with respect to FIG. 6. Such programming may be built-in to the augmented reality device (e.g., integrated into an operating system or preinstalled application), and/or provided by another application or service. In some implementations, the augmented reality device may include a calibration program allowing a user to repeatedly perform one or more gestures, thereby allowing the augmented reality device to more accurately detect the trained gestures in the future. Gestures may be detected using any of the hand tracking modalities discussed above, including via one or more cameras, sensors/markers affixed to or worn on the hand, etc.

In some cases, the virtual dial control may have a bounding box taking the form of a 2D or 3D region of space surrounding the virtual dial control. The dial-rotation-initiating gesture may therefore be detected while the human hand has an effective virtual position that is within or intersecting the bounding box. Depending on the implementation, however, the human hand need not always have an effective virtual position that is proximate to or intersecting the virtual dial control when the dial-rotation-initiating gesture is performed. In cases where the effective virtual position of the human hand is distant from the virtual dial control when the dial-rotation-initiating gesture is performed, it can be more difficult for the augmented reality device to associate the dial-rotation-initiating gesture with the virtual dial control. Thus, in some examples, detecting the dial-rotation-initiating gesture may include detecting a secondary input targeting the virtual dial control. Notably, it may be beneficial for the augmented reality device to detect and interpret a secondary input regardless of the proximity of the effective virtual position of the hand to the virtual dial control. As examples, a secondary input can include data from a gaze tracker (e.g., indicating that the user is looking at the virtual dial control), a vocal command, a gesture performed by a second hand of the user, an input provided by a separate device (e.g., a handheld controller or pointer), etc.

Turning now to FIG. 3B, once the dial-rotation-initiating gesture is detected at the first effective virtual position, the augmented reality device may recognize a first point on the virtual dial control that corresponds to a starting point for the rotation. Specifically, FIG. 3B again shows virtual dial control 300 and first effective virtual position 308A. FIG. 3B also depicts a reference line 310A extending between the center of the virtual dial control and the first effective virtual position. A first point 312A falls along reference line 310A at an edge of the virtual dial control. Thus, first point 312A may be used as a “starting point” for user rotation of the virtual dial control. Once a dial-rotation-terminating gesture is detected, an “end point” may be compared to point 312A to determine the extent of the rotation of the virtual dial control. Notably, both reference line 310A and first point 312A may or may not be visually displayed by the augmented reality device, and first point 312A may be recognized at any position along reference line 310A, not just at the edge of the dial.

Returning briefly to FIG. 2, at 210, method 200 includes tracking a dial-rotating movement of the human hand from the first real-world 3D position to a second real-world 3D position that corresponds to a second effective virtual position relative to the virtual coordinate system. This is illustrated in FIG. 3C, in which human hand 302 has moved to a second real-world 3D position, indicated by dashed circle 306B. The second real-world 3D position is translated into a second effective virtual position, indicated by dashed circle 308B on virtual plane 304. The first real-world 3D position, as well as the first effective virtual position, are still represented by dashed circles 306A and 308A for reference. Movement of the human hand may be tracked in any suitable way, as discussed above with regard to initial detection of the first real-world 3D position of the hand.

Turning now to FIG. 3D, virtual dial control 300 is again shown, along with second effective virtual position 308B. A second reference line 310B now extends between the center of the virtual dial control and the second effective virtual position of the human hand. The augmented reality device recognizes a second point 312B that falls along second reference line 312B and corresponds to an end point of the rotation. Thus, movement of the hand has resulted in a simulated rotation of the virtual dial control from a starting point, indicated by first point 312A, to an end point, indicated by second point 312B, resulting in a 60-degree clockwise rotation of the virtual dial control 300.

Returning briefly to FIG. 2, at 212, method 200 includes detecting a dial-rotation-terminating gesture from the human hand at the second effective virtual position. As with the dial-rotation-initiating gesture, the dial-rotation-terminating gesture may take any suitable. The dial-rotation-terminating gesture may in various cases be the same as, or different from, the dial-rotation-initiating gesture. In some cases, the dial-rotation-terminating gesture may be detected when the dial-rotation-initiating gesture is released. For instance, when the dial-rotation-initiating gesture is a pinch gesture (or other similar gesture), the dial-rotation-initiating gesture may be maintained for the duration of the rotation of the virtual dial control. Thus, detecting the dial-rotation-terminating gesture may simply include determining that the dial-rotation-initiating gesture is no longer being performed—e.g., the fingers of the hand have separated and are no longer pinching.

The dial-rotation-terminating gesture may be detected in any suitable way. For example, the gesture may be detected by a gesture-detecting machine that optionally utilizes a previously trained machine learning classifier to detect one or more specific gestures, including dial-rotation-terminating gestures. This will be described in more detail below with respect to FIG. 6.

During the interval of time in which the virtual dial control is being rotated—between detection of the dial-rotation-initiating gesture and dial-rotation-terminating gesture—the augmented reality device may provide any suitable feedback to represent turning of the virtual dial control. This may include one or more of visual feedback, audible feedback, haptic feedback, and/or other suitable feedback.

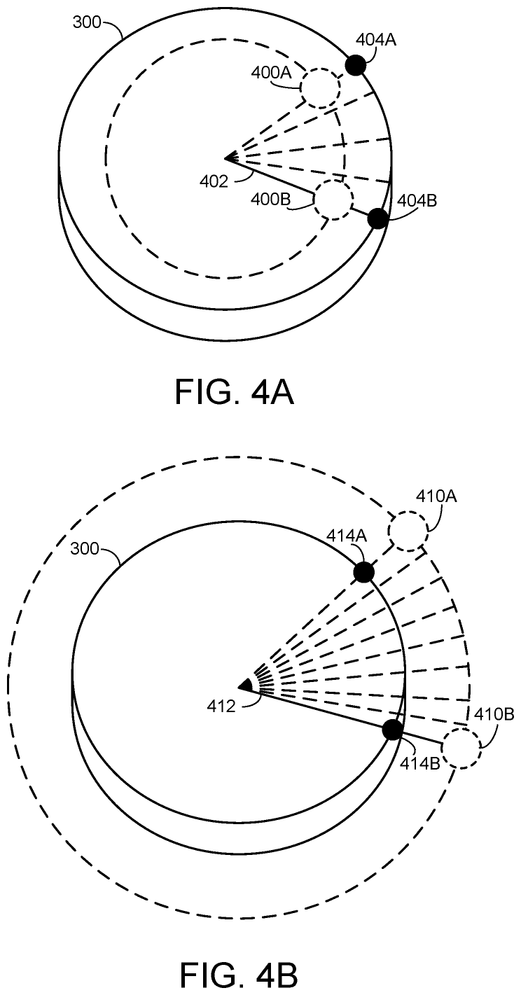

Visual feedback during rotation of a virtual dial control is illustrated with respect to FIGS. 4A and 4B. Specifically, in FIG. 4A, a human hand has moved from a first effective virtual position 400A to a second effective virtual position 400B. A reference line 402 extends from the center of the virtual dial control, through second effective virtual position 400B, and to a second point 404B, representing the endpoint of the rotation at which the dial-rotation-terminating gesture was detected. A first point 404A, representing the starting point of the rotation at which the dial-rotation-initiating gesture was detected, is shown for reference. In this example, reference line 402 is displayed to the user as a form of visual feedback during rotation of the virtual dial control. Multiple former positions of the reference line during the rotation of the virtual dial control are shown as dashed lines.

It will be understood that visual feedback may be provided in any number of ways, and the visual feedback shown in FIG. 4A is a nonlimiting example. In general, providing visual feedback will involve displaying one or more markers or reference points, which may follow the rotation of the virtual dial control during the rotation.

As discussed above, various types of feedback may be provided in addition to or as an alternative to visual feedback. For example, during rotation of the virtual dial control, the augmented reality device may play one or more audible sounds—e.g., a clicking sound—which may be discontinued when the dial-rotation-terminating gesture is detected. Additionally, or alternatively, and depending on the form factor of the augmented reality device, haptic feedback may be provided. For instance, when the augmented reality device has a handheld form factor, or a handheld controller, pointer, or other suitable device is held in the user's hand, then vibration may be used to represent turning of the virtual dial control.

Notably, in contrast to physical dials, the virtual dial control may be rotated regardless of whether the position of the human hand (either the real-world 3D position or the effective virtual position) is at or near the apparent 3D position of the virtual dial control. Thus, the virtual dial control may be rotated with variable degrees of precision depending on the distance between the effective virtual position of the hand and the center of the virtual dial control. For example, in FIG. 4A, both the first and second effective virtual positions of the human hand are relatively close to the center of the virtual dial control. This is emphasized by the dashed circle intersecting both the first and second effective virtual positions. Given this, movement of the human hand over a relatively short physical distance may result in a relatively large angular rotation of the virtual dial control.

By contrast, FIG. 4B illustrates a different rotation of virtual dial control 300 caused by a different movement of the human hand from a first effective virtual position 410A to a second effective virtual position 410B. Once again, a reference line 412 serves as visual feedback and passes through a first point 414A on the edge of the dial at the start of the rotation and a second point 414B on the edge of the dial at the end of the rotation. In both FIGS. 4A and 4B, the angular rotation of the virtual dial control is the same. However, in FIG. 4B, the first and second effective virtual positions of the human hand are further from the center of the virtual dial control, as the dashed circle intersecting positions 410A and 410B has a longer radius. Thus, despite the movement of the human hand covering a greater physical distance, the same angular rotation of the dial is achieved. This allows for more precise control over rotation of the dial as needed, while still allowing for more coarse adjustments, depending on the distance between the effective virtual position of the hand and the center of the dial.

As discussed above, in some cases, rotation of the virtual dial control may result in adjustment of an adjustable parameter associated with the augmented reality device or another device or system. In some cases, such adjustment may be done in proportion to a separation between the first point and second point on the edge of the virtual dial control, corresponding to the starting and ending points of the rotation. Furthermore, rotation of the virtual dial control may result in adjustment of any of a variety of adjustable parameters associated with the augmented reality device or another device or system. In the example of FIG. 1, rotation of the virtual dial control adjusts a volume with which the augmented reality device plays audio. In general, the virtual dial control may be useful for selecting values—e.g., setting a volume, changing a channel, altering equalizer settings, changing a display brightness, tuning to a specific frequency—and/or providing any other suitable functions or controls with respect to the augmented reality device or another device or system.

For instance, in one example, the virtual dial control may be used to input numbers in a phone dialer app. A mobile device, such as a smartphone, may be configured to present a virtual dial control as part of a standard graphical user interface for placing phone calls. Such a virtual dial control may be rotated substantially as described above with respect to FIG. 2. Specifically, the mobile phone may detect a dial-rotation-initiating gesture, dial-rotating movement, and dial-rotation-terminating gesture from a human hand, for instance via a camera of the mobile phone, and rotate the virtual dial control in accordance with the detected movements. In this manner, a virtual dial control may be implemented on any suitable device regardless of form factor, and may be used to control any suitable adjustable parameter—e.g., inputting phone numbers. Furthermore, the virtual dial may be implemented in a conventional virtual space, such as a standard graphical user interface, that is not used to provide virtual or augmented reality enhancements.

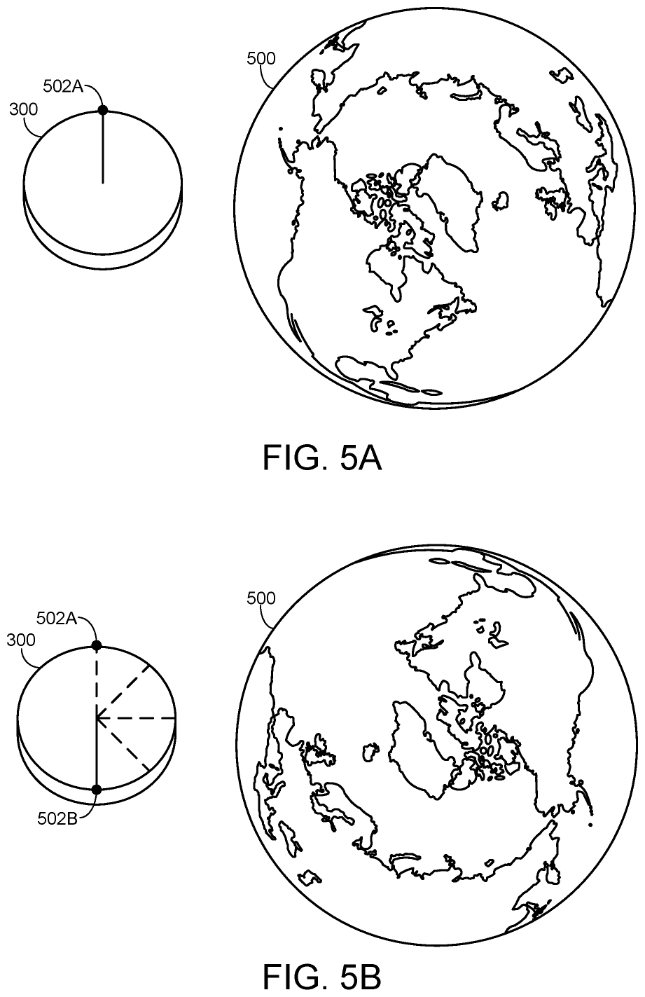

As another example, the augmented reality device may display a virtual object, and adjusting the adjustable parameter associated with the augmented reality device may include changing a visual property of the virtual object. This is illustrated with respect to FIGS. 5A and 5B, which again show virtual dial control 300 alongside a virtual object 500 displayed by the augmented reality device, specifically taking the form of a virtual globe. In FIG. 5A, the globe is presented as having a particular 3D virtual pose. Thus, adjusting the visual property may include changing the 3D virtual pose of the globe. For instance, the 3D virtual pose may be a six degree-of-freedom (6DOF) virtual pose, and adjusting the adjustable parameter may including adjusting a first degree-of-freedom of the 6DOF virtual pose.

This is illustrated in FIGS. 5A and 5B. In FIG. 5A, rotation of the virtual dial control has begun, as indicated by a reference line extending to a first point 502A shown at the top of the virtual dial control. In FIG. 5B, rotation of the virtual dial control is discontinued, as indicated by the reference line extending to a second point 502B shown at the bottom of the virtual dial control. In other words, between FIGS. 5A and 5B, the virtual dial control is rotated 180 degrees. Similarly, the virtual globe 500 has also rotated 180 degrees about an axis extending into the page. Thus, rotation of the virtual dial control has resulted in a change in a first degree-of-freedom of the 6DOF pose of the virtual globe. Notably, in this example, there is a 1:1 relationship between rotation of the dial and rotation of the globe, as both the dial and globe are rotated by 180 degrees. However, it will be understood that this need not always be the case.

The degree-of-freedom affected by rotation of the virtual dial control may be selected in any suitable way. In one example, the degree-of-freedom adjusted by the virtual dial control may be specified by a suitable user input prior to detection of the dial-rotation-initiating gesture from the human hand. Alternatively, the augmented reality device may display multiple virtual dial controls, each configured to adjust different degrees-of-freedom of the 6DOF virtual pose. For instance, one virtual dial control may adjust pitch, while other dials adjust yaw, roll, and positions relative to the X, Y, and Z axes. Notably, in some examples, movement/rotation of a virtual object may be constrained by nearby real or virtual objects, which may affect the degrees-of-freedom adjustable through rotation of a virtual dial control.

Additionally, or alternatively, a virtual dial control may be used to change other visual properties of a virtual object. As additional examples, adjusting the adjustable parameter associated with the augmented reality device may include changing the size of a virtual object, changing the color of the virtual object, applying various transforms to the virtual object—e.g., stretching, shearing, squeezing—and/or changing any other visual properties of the virtual object.

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 6 schematically shows a simplified representation of a computing system 600 configured to provide any to all of the compute functionality described herein. Computing system 600 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 600 includes a logic subsystem 602 and a storage subsystem 604. Computing system 600 may optionally include a display subsystem 606, input subsystem 608, communication subsystem 610, and/or other subsystems not shown in FIG. 6.

Logic subsystem 602 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 604 includes one or more physical devices configured to temporarily and/or permanently hold computer information such as data and instructions executable by the logic subsystem. When the storage subsystem includes two or more devices, the devices may be collocated and/or remotely located. Storage subsystem 604 may include volatile, nonvolatile, dynamic, static, read/write, read-only, random-access, sequential-access, location-addressable, file-addressable, and/or content-addressable devices. Storage subsystem 604 may include removable and/or built-in devices. When the logic subsystem executes instructions, the state of storage subsystem 604 may be transformed—e.g., to hold different data.

Aspects of logic subsystem 602 and storage subsystem 604 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

Machines may be implemented using any suitable combination of state-of-the-art and/or future machine learning (ML), artificial intelligence (AI), and/or natural language processing (NLP) techniques. Non-limiting examples of techniques that may be incorporated in an implementation of one or more machines include support vector machines, multi-layer neural networks, convolutional neural networks (e.g., including spatial convolutional networks for processing images and/or videos, temporal convolutional neural networks for processing audio signals and/or natural language sentences, and/or any other suitable convolutional neural networks configured to convolve and pool features across one or more temporal and/or spatial dimensions), recurrent neural networks (e.g., long short-term memory networks), associative memories (e.g., lookup tables, hash tables, Bloom Filters, Neural Turing Machine and/or Neural Random Access Memory), word embedding models (e.g., GloVe or Word2Vec), unsupervised spatial and/or clustering methods (e.g., nearest neighbor algorithms, topological data analysis, and/or k-means clustering), graphical models (e.g., (hidden) Markov models, Markov random fields, (hidden) conditional random fields, and/or AT knowledge bases), and/or natural language processing techniques (e.g., tokenization, stemming, constituency and/or dependency parsing, and/or intent recognition, segmental models, and/or super-segmental models (e.g., hidden dynamic models)).

In some examples, the methods and processes described herein may be implemented using one or more differentiable functions, wherein a gradient of the differentiable functions may be calculated and/or estimated with regard to inputs and/or outputs of the differentiable functions (e.g., with regard to training data, and/or with regard to an objective function). Such methods and processes may be at least partially determined by a set of trainable parameters. Accordingly, the trainable parameters for a particular method or process may be adjusted through any suitable training procedure, in order to continually improve functioning of the method or process.

Non-limiting examples of training procedures for adjusting trainable parameters include supervised training (e.g., using gradient descent or any other suitable optimization method), zero-shot, few-shot, unsupervised learning methods (e.g., classification based on classes derived from unsupervised clustering methods), reinforcement learning (e.g., deep Q learning based on feedback) and/or generative adversarial neural network training methods, belief propagation, RANSAC (random sample consensus), contextual bandit methods, maximum likelihood methods, and/or expectation maximization. In some examples, a plurality of methods, processes, and/or components of systems described herein may be trained simultaneously with regard to an objective function measuring performance of collective functioning of the plurality of components (e.g., with regard to reinforcement feedback and/or with regard to labelled training data). Simultaneously training the plurality of methods, processes, and/or components may improve such collective functioning. In some examples, one or more methods, processes, and/or components may be trained independently of other components (e.g., offline training on historical data).

When included, display subsystem 606 may be used to present a visual representation of data held by storage subsystem 604. This visual representation may take the form of a graphical user interface (GUI). Display subsystem 606 may include one or more display devices utilizing virtually any type of technology. In some implementations, display subsystem may include one or more virtual-, augmented-, or mixed reality displays.

When included, input subsystem 608 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 610 may be configured to communicatively couple computing system 600 with one or more other computing devices. Communication subsystem 610 may include wired and/or wireless communication devices compatible with one or more different communication protocols. The communication subsystem may be configured for communication via personal-, local- and/or wide-area networks.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, a method for an augmented reality device comprises: displaying a virtual dial control having a virtual three-dimensional position in a virtual coordinate system; detecting a first real-world three-dimensional position of a human hand; translating the first real-world three-dimensional position of the human hand into a first effective virtual position relative to the virtual coordinate system; detecting a dial-rotation-initiating gesture from the human hand at the first effective virtual position; tracking a dial-rotating movement of the human hand from the first real-world three-dimensional position to a second real-world three-dimensional position corresponding to a second effective virtual position relative to the virtual coordinate system; and detecting a dial-rotation-terminating gesture from the human hand at the second effective virtual position. In this example or any other example, the virtual dial control is configured to adjust an adjustable parameter associated with the augmented reality device. In this example or any other example, the method further comprises: recognizing a first point on the virtual dial that falls along a first reference line extending between a center of the virtual dial control and the first effective virtual position of the human hand; recognizing a second point on the virtual dial that falls along a second reference line extending between a center of the virtual dial control and the second effective virtual position of the human hand; and adjusting the adjustable parameter in proportion to a separation between the first point and the second point. In this example or any other example, the method further comprises displaying a virtual object, and adjusting the adjustable parameter associated with the augmented reality device includes changing a visual property of the virtual object. In this example or any other example, the visual property of the virtual object is a three-dimensional virtual pose of the virtual object, and adjusting the adjustable parameter includes changing the three-dimensional virtual pose. In this example or any other example, the three-dimensional virtual pose of the virtual object is a six degree-of-freedom (6DOF) virtual pose, and adjusting the adjustable parameter includes adjusting a first degree-of-freedom of the 6DOF virtual pose. In this example or any other example, the first degree-of-freedom adjusted by the virtual dial control is specified by a user input prior to detecting the dial-rotation-initiating gesture from the human hand. In this example or any other example, the method further comprises displaying one or more additional virtual dial controls each configured to adjust one or more additional degrees-of-freedom of the 6DOF virtual pose. In this example or any other example, the visual property of the virtual object is a size of the virtual object, and adjusting the adjustable parameter includes changing the size of the virtual object. In this example or any other example, the adjustable parameter is a volume setting of the augmented reality device. In this example or any other example, the adjustable parameter is a display brightness associated with a display of the augmented reality device. In this example or any other example, the virtual dial control has a bounding box, and the dial-rotation-initiating gesture is detected while the first effective virtual position of the human hand is within the bounding box. In this example or any other example, detecting the dial-rotation-initiating gesture further includes detecting a secondary input targeting the virtual dial control. In this example or any other example, the dial-rotation-initiating gesture is a pinch gesture. In this example or any other example, the method further comprises, while the human hand is at the first real-world three-dimensional position, displaying a virtual representation of the human hand at the first effective virtual position. In this example or any other example, the virtual three-dimensional position of the virtual dial control is on a virtual plane, and translating the first real-world position of the human hand into the first effective virtual position relative to the virtual coordinate system includes projecting the first real-world 3D position of the human hand onto the virtual plane. In this example or any other example, the method further comprises, while tracking the movement of the human hand, providing one or more of visual feedback, audible feedback, and haptic feedback to represent rotation of the virtual dial control. In this example or any other example, the virtual dial control is displayed via a near-eye display of the augmented reality device.

In an example, an augmented reality device comprises: a display; a logic subsystem; and a storage subsystem holding instructions executable by the logic subsystem to: display, via the display, a virtual dial control having a virtual three-dimensional position in a virtual coordinate system; detect a first real-world three-dimensional position of a human hand; translate the first real-world three-dimensional position of the human hand into a first effective virtual position relative to the virtual coordinate system; detect a dial-rotation-initiating gesture from the human hand at the first effective virtual position; track a dial-rotating movement of the human hand from the first real-world three-dimensional position to a second real-world three-dimensional position corresponding to a second effective virtual position relative to the virtual coordinate system; and detect a dial-rotation-terminating gesture from the human hand at the second effective virtual position.

In an example, a method for an augmented reality device comprises: displaying, via a near-eye display of the augmented reality device, a virtual dial control having a virtual three-dimensional position in a virtual coordinate system, the virtual dial control configured to adjust an adjustable parameter associated with the augmented reality device; detecting a first real-world three-dimensional position of a human hand; translating the first real-world three-dimensional position of the human hand into a first effective virtual position relative to the virtual coordinate system; detecting a dial-rotation-initiating gesture from the human hand at the first effective virtual position; recognizing a first point on the virtual dial that falls along a first reference line extending between a center of the virtual dial control and the first effective virtual position of the human hand; tracking a dial-rotating movement of the human hand from the first real-world three-dimensional position to a second real-world three-dimensional position corresponding to a second effective virtual position relative to the virtual coordinate system; recognizing a second point on the virtual dial that falls along a second reference line extending between a center of the virtual dial control and the second effective virtual position of the human hand; adjusting the adjustable parameter in proportion to a separation between the first point and the second point; and detecting a dial-rotation-terminating gesture from the human hand at the second effective virtual position.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for an augmented reality device, comprising:
displaying a virtual dial control having a virtual three-dimensional position in a virtual coordinate system, the virtual dial control having a bounding box surrounding the virtual dial control;
detecting a first real-world three-dimensional position of a human hand;
translating the first real-world three-dimensional position of the human hand into a first effective virtual position within the bounding box relative to the virtual coordinate system;
detecting a dial-rotation-initiating gesture from the human hand at the first effective virtual position while the first effective virtual position remains within the bounding box;
tracking a dial-rotating movement of the human hand from the first real-world three-dimensional position to a second real-world three-dimensional position corresponding to a second effective virtual position outside of the bounding box relative to the virtual coordinate system, wherein the virtual dial control rotates with a variable degree of precision that proportionally increases as a distance between the first real-world three-dimensional position of the human hand and the second real-world three-dimensional position of the human hand increases; and
detecting a dial-rotation-terminating gesture from the human hand at the second effective virtual position.

2. The method of claim 1, where the virtual dial control is configured to adjust an adjustable parameter associated with the augmented reality device.

3. The method of claim 2, further comprising:
recognizing a first point on the virtual dial that falls along a first reference line extending between a center of the virtual dial control and the first effective virtual position of the human hand;
recognizing a second point on the virtual dial that falls along a second reference line extending between a center of the virtual dial control and the second effective virtual position of the human hand; and
adjusting the adjustable parameter in proportion to a separation between the first point and the second point.

4. The method of claim 2, further comprising displaying a virtual object, and where adjusting the adjustable parameter associated with the augmented reality device includes changing a visual property of the virtual object.

5. The method of claim 4, where the visual property of the virtual object is a three-dimensional virtual pose of the virtual object, and adjusting the adjustable parameter includes changing the three-dimensional virtual pose.

6. The method of claim 5, where the three-dimensional virtual pose of the virtual object is a six degree-of-freedom (6DOF) virtual pose, and adjusting the adjustable parameter includes adjusting a first degree-of-freedom of the 6DOF virtual pose.

7. The method of claim 6, where the first degree-of-freedom adjusted by the virtual dial control is specified by a user input prior to detecting the dial-rotation-initiating gesture from the human hand.

8. The method of claim 6, further comprising displaying one or more additional virtual dial controls each configured to adjust one or more additional degrees-of-freedom of the 6DOF virtual pose.

9. The method of claim 4, where the visual property of the virtual object is a size of the virtual object, and adjusting the adjustable parameter includes changing the size of the virtual object.

10. The method of claim 2, where the adjustable parameter is a volume setting of the augmented reality device.

11. The method of claim 2, where the adjustable parameter is a display brightness associated with a display of the augmented reality device.

12. (canceled)

13. The method of claim 1, where detecting the dial-rotation-initiating gesture further includes detecting a secondary input targeting the virtual dial control.

14. The method of claim 1, where the dial-rotation-initiating gesture is a pinch gesture.

15. The method of claim 1, further comprising, while the human hand is at the first real-world three-dimensional position, displaying a virtual representation of the human hand at the first effective virtual position.

16. The method of claim 1, where the virtual three-dimensional position of the virtual dial control is on a virtual plane, and where translating the first real-world position of the human hand into the first effective virtual position relative to the virtual coordinate system includes projecting the first real-world 3D position of the human hand onto the virtual plane.

17. The method of claim 1, further comprising, while tracking the movement of the human hand, providing one or more of visual feedback, audible feedback, and haptic feedback to represent rotation of the virtual dial control.

18. The method of claim 1, where the virtual dial control is displayed via a near-eye display of the augmented reality device.

19. An augmented reality device, comprising:
a display;
a logic subsystem; and
a storage subsystem holding instructions executable by the logic subsystem to:
display, via the display, a virtual dial control having a virtual three-dimensional position in a virtual coordinate system, the virtual dial control having a bounding box surrounding the virtual dial control;
detect a first real-world three-dimensional position of a human hand;
translate the first real-world three-dimensional position of the human hand into a first effective virtual position within the bounding box relative to the virtual coordinate system;
detect a dial-rotation-initiating gesture from the human hand at the first effective virtual position while the first effective virtual position remains within the bounding box;
track a dial-rotating movement of the human hand from the first real-world three-dimensional position to a second real-world three-dimensional position corresponding to a second effective virtual position outside of the bounding box relative to the virtual coordinate system, wherein the virtual dial control rotates with a variable degree of precision that proportionally increases as a distance between the first real-world three-dimensional position of the human hand and the second real-world three-dimensional position of the human hand increases; and
detect a dial-rotation-terminating gesture from the human hand at the second effective virtual position.

20. A method for an augmented reality device, comprising:
displaying, via a near-eye display of the augmented reality device, a virtual dial control having a virtual three-dimensional position in a virtual coordinate system, the virtual dial control configured to adjust an adjustable parameter associated with the augmented reality device, the virtual dial control having a bounding box surrounding the virtual dial control;
detecting a first real-world three-dimensional position of a human hand;
translating the first real-world three-dimensional position of the human hand into a first effective virtual position within the bounding box relative to the virtual coordinate system;
detecting a dial-rotation-initiating gesture from the human hand at the first effective virtual position while the first effective virtual position remains within the bounding box;
recognizing a first point on the virtual dial that falls along a first reference line extending between a center of the virtual dial control and the first effective virtual position of the human hand;
tracking a dial-rotating movement of the human hand from the first real-world three-dimensional position to a second real-world three-dimensional position corresponding to a second effective virtual position outside of the bounding box relative to the virtual coordinate system, wherein the virtual dial control rotates with a variable degree of precision that proportionally increases as a distance between the first real-world three-dimensional position of the human and the second real-world three-dimensional position of the human hand increases;
recognizing a second point on the virtual dial that falls along a second reference line extending between a center of the virtual dial control and the second effective virtual position of the human hand;
adjusting the adjustable parameter in proportion to a separation between the first point and the second point; and
detecting a dial-rotation-terminating gesture from the human hand at the second effective virtual position.
